(19) United States
(12) Patent Application Publication
(10) Pub. No.: US 2018/0308087 A1
(43) Pub. Date: Oct. 25, 2018

(54) SYSTEM AND METHOD FOR MANAGEMENT OF A SMART OBJECT

(71) Applicant: Moti MAIMON, Ramat Hasharon (IL)

(72) Inventor: MOTI MAIMON, RAMAT HASHARON (IL)

(21) Appl. No.: 15/767,653

(22) PCT Filed: Oct. 13, 2016
(86) PCT No.: PCT/IL2016/000017

§ 371 Date: Apr. 12, 2018

Related U.S. Application Data
(60) Provisional application No. 62/241,182, filed on Oct. 14, 2015.
(60) Provisional application No. 62/395,415, filed on Sep. 16, 2016.

(30) Foreign Application Priority Data
Nov. 24, 2015 (IL) 242762

(51) Int. Cl. G06Q 20/32; G06F 8/60; H04L 9/08; G06Q 20/40; G06Q 20/34

(52) U.S. Cl. CPC G06Q 20/3278; G06F 8/60; G06Q 20/356; G06Q 20/40; G06Q 20/3552; H04L 9/0822

(57) ABSTRACT

A system and method for performing an operation on a smart object, the system including at least one user interface, having access to the Internet, including a smart object reader/writer and a processor, a universal, multi-platform “dumb” SDK (Software Development Kit), supporting multi-platform communication, embedded in each user interface, a central management unit disposed in the Cloud, configured to operate under multiple platforms and to communicate over multiple standards, in two-way communication with each smart object via its SDK, at least one provider backend in communication with the at least one user interface and with the central management unit, a secure encryption unit proving a physical key for each communication between each SDK and the central management unit, and a web services managing server configured to provide secure two-way communication between each user interface, the secure encryption unit, the provider backend and the central management unit.

### RELATED APPLICATIONS

This application claims the benefit of US provisional patent application Nos. 62/241,182, filed 14 Oct. 2015, and 62/395,415, filed 16 Sep. 2016, and Israeli patent application number 242762, filed 24 Nov. 2015.

### FIELD OF THE INVENTION

The present invention relates to methods and systems for managing smart objects, such as smart cards, host card emulation and portable objects.

### BACKGROUND OF THE INVENTION

Smart cards, smart portable objects and other smart objects are well known. A smart card or portable object is a personal and portable device associated with a particular cardholder that includes an embedded integrated circuit that can be a secure microcontroller or equivalent intelligence with internal memory or a memory chip alone. The card connects to a card reader with direct physical contact or via a remote contactless radio frequency interface. With an embedded microcontroller, smart cards have the ability to store large amounts of data, carry out their own on-card functions (e.g., encryption and mutual authentication) and interact intelligently with a smart card reader and writer, and the reader/writer can read from and/or write to the smart card. Smart card technology is available in a variety of form factors, including plastic cards, key fobs, watches, subscriber identification modules used in GSM mobile phones, and USB-based tokens. For the purposes of this application, “smart object” is used as the generic term to describe any device in which smart card technology is used. Smart card technology can also be built into other portable personal devices, such as mobile phones and USB devices, which then become smart objects, themselves. Smart phones can also include a module for reading or writing on other smart objects, such as traditional smart cards. Smart objects can be integrated in mobile devices, using Host Card Emulation (HCE) technology or other portable object emulation without a physical card.

Smart objects can provide personal identification, authentication, data storage, and application processing. Europay MasterCard Visa (EMV)-compliant credit cards, and the complementary card readers, are widespread. In addition to smart card readers, there are also contactless smart cards that do not require physical contact between a card and reader. It is possible to “read” the data on a contactless smart object using Near-field communication (NFC). NFC is a set of communication protocols that enable two electronic devices, one of which is usually a portable device such as a smartphone, to establish communication by bringing them within about 4 cm (2 in) of each other. Typical uses of contactless smart objects are for payment and ticketing, include mass transit and motorway tolls. Smart cards are also being introduced for identification and entitlement by regional, national, and international organizations. These uses include citizen cards, drivers' licenses, and patient cards, as well as some biometric passports to enhance security for international travel.

At present, in order to load data for services, such as a travel fare contract, or to prepay for a pre-selected quantity of services (i.e., to load or add value to the smart object), it is necessary to take the smart object to an authorized loading location, typically having a fare vending machine or an add value machine, to physically load the data on the smart or portable object (i.e., record the data and/or contract in the memory of the smart object), one card at a time. Online options are limited to online payment, with the actual loading onto the card taking place in an authorized machine. This is a time-consuming process and requires all users to queue up in a few select locations to load value to their smart objects, one after the other. There actually does not exist a single system that allows users to add value or load data or contracts of various services to a multitude of smart objects operating under various technologies, online via the Internet and Cloud services.

In addition, applicant has discovered that smart phones having NFC capabilities can be used to read from and/or write on smart objects, such as smart travel cards (for example, the Ray Kay transportation card in Israel). However, this is not possible today using every existing cellphone device, particularly when working with NFC technology in cellular devices having the Android Operating System. Many models running the Android operating system, including the newest models to be introduced to the market, do not support work with smart objects through NFC connectivity. For example, these read and write actions cannot be performed using the following devices: NEXUS 5, GALAXY 6, ONE PLUS, and many others.

Accordingly, there is a long felt need for a method and system permitting remote loading via Internet communications and Cloud services, of a smart objects or smart portable objects and it would be desirable to perform read/write operations on smart objects using various devices running all kinds of operating systems including all the Android operating systems.

### BRIEF DESCRIPTION OF THE DRAWINGS

The present invention will be further understood and appreciated from the following detailed description taken in conjunction with the drawings in which:

FIG. 1a is a schematic illustration of a system and method for performing operations on a smart object, constructed and operative in accordance with some embodiments of the present invention;

FIG. 1b is a block diagram illustration of an architecture for a management system for performing operations on a smart object, constructed and operative in accordance with some embodiments of the present invention;

FIGS. 2a, 2b and 2c are schematic block diagram illustrations of provider's client units according to some embodiments of the invention;

FIG. 3 is a schematic illustration of a method for performing operations on a smart object using a browser and a smart object reader/writer according to embodiments of the invention;

FIG. 4 is a flow chart illustrating a method of updating a profile on a smart object according to embodiments of the invention;

FIG. 5 is a block diagram illustrating a method of updating a profile on a smart object according to embodiments of the invention;

FIG. 6 is a flow chart of a method for creating a communication channel between a smart card and a smart phone, in accordance with some embodiments of the present invention; and

FIG. 7 is a flow chart of a method for creating a communication channel between a smart card and a smart phone, in accordance with alternative embodiments of the present invention.

### SUMMARY OF THE INVENTION

The present invention relates to systems and methods for remote managing of smart objects, such as smart cards, by means of communication devices having access to the Internet and Cloud services.

The present invention further relates to a system for creating a communication channel between a smart object and a smart processing device. The system includes a smart object or smart portable object, i.e. a smart processing device having a detector/sensor (such as NFC chip) for detecting the smart object or emulating it, where the smart device runs an operating system; an NFC (Near Field Communication) chip disposed in the smart device and arranged to establish a communication channel between the smart processing device and the smart object for performing a transaction on the smart object.

According to embodiments of the invention, the system is configured to switch operation of the Android operating system between two modes when the detector detects the smart object adjacent the smart processing device: a first mode, wherein the NFC chip is arranged to output a signal to the smart object after each of the fixed-length time delay intervals; and a second mode, wherein the NFC chip is arranged to output a signal after at least one pre-selected time delay interval longer than the fixed-length time delay interval, thereby preventing disconnection of the communication channel while the transaction is performed over the communication channel.

According to embodiments of the invention, there is provided a system for performing an operation on a smart object, the system including at least one user interface, having access to the Internet and Cloud services, including a smart object reader/writer and a processor, a universal, multi-platform “dumb” SDK (Software Development Kit), supporting multi-platform communication, which is embedded in each said user interface, a central management unit disposed in the Cloud, configured to operate under multiple platforms and to communicate over multiple standards, in two-way communication with each smart object via its SDK, at least one provider backend in communication with the at least one user interface and with the central management unit, a secure encryption unit providing a key for each communication between each SDK and the central management unit, and a web services managing server configured to provide secure two-way communication between each user interface, the secure encryption unit, the provider backend and the central management unit.

According to alternative embodiments of the invention, the key for each communication between each said SDK and the central management unit is a physical key. According to alternative embodiments of the invention, the system further includes a proxy server to permit a user interface and central management unit, which use different communication protocols, to communicate with one another.

According to alternative embodiments of the invention, the user interface is a personal computer running an Internet browser and having an attached object reader/writer the SDK includes two SDKs: a desktop SDK installed on the personal computer and a browser SDK embedded in the provider backend and accessible via the PC. The desktop SDK and the browser SDK communicate with one another via a proxy.

According to alternative embodiments of the invention, the communication channel between the desktop SDK and the browser SDK includes two secure Web Socket connections, based on a common encryption key, one between the desktop SDK and the proxy server and the second between the browser SDK and the proxy server, to permit transfer of data between the desktop SDK and the browser SDK.

According to yet other alternative embodiments of the invention, the provider backend is configured to perform operations on multiple smart objects simultaneously.

According to still other alternative embodiments of the invention, there is provided a system for creating a communication channel between a smart object and a smart processing device. The system includes a smart object, a smart processing device having a detector for detecting the smart object, the device running an Android operating system having a timer, an NFC (Near Field Communication) chip disposed in the smart device and arranged to establish a communication channel between the smart processing device and the smart object for performing a transaction on the smart object, and to output signals at pre-set fixed-length time delay intervals of the timer to the smart object. The system further includes an application having a module arranged to switch operation of the Android operating system between two modes when the detector detects the smart object adjacent the smart processing device: a first mode wherein the NFC chip is arranged to output a signal to the smart object after each of the fixed-length time delay intervals, and a second mode wherein the NFC chip is arranged to output a signal after at least one pre-selected time delay interval longer than the fixed-length time delay interval, thereby preventing disconnection of the communication channel while the transaction is performed over the communication channel.

### DETAILED DESCRIPTION OF THE INVENTION

The present invention relates to a management system and method for remotely performing operations on a smart card or other smart object having a processor and a memory, whatever its form (e.g., card, watch, mobile phone, computer, portable object, secure element, Host Card Emulation, portable object emulation, etc.), over the Internet or another communication network. The operations may include reading, writing, erasing, locking, and sending instructions to be performed by the smart object. The system and method of the invention are implemented by means of a central management unit that can operate under a wide variety of different platforms and communicate over multiple standards, and a generic SDK (Software Development Kit) element. The SDK is a “dumb” component that communicates with the central management unit and is embedded in the user interface (smart object reader/writer) in order to permit communication between the central management unit and smart objects via the SDK. Thus, the SDK is configured to transfer data from the smart object to the central management unit and vice versa. In addition, the system permits management of “many to many” sales, i.e., sales by multiple distributors of products of multiple service providers. At the same time, the system is extremely secure, as it provides strong authentication during remote access, by means of physical encryption keys in a server associated with the central management unit, using advanced secure mechanisms. Where necessary, communication is provided via a proxy server to permit components, which use different communication protocols, to communicate with one another.

One application for which the invention is particularly suitable is reading and modifying smart objects, particularly portable objects, used as tickets for public transportation. In this case, the operations include reading to determine a current value, and writing to load contracts or value (e.g., for recording a positive money balance) or personal details or identifying documents to the smart object remotely by means of the Internet. In addition, the system can be used to validate the object or to personalize the end user's profile, including indicating special benefits due the user from various service providers. The central management unit is disposed in the Cloud and can be accessed from anywhere in the world via the World Wide Web (Internet).

The system and method are operative on substantially any processing platform (end user interface) having access to the Internet. These platforms can include, but are not limited to, a smart cellular phone, tablet, Point of Sale (POS) station having an operating system, a kiosk, ATM, a personal computer with any browser, and so forth. Thus, the end user station (user interface) can be a personal computer connected to the Internet having an embedded SDK and a dedicated smart card reader and writer, a smart phone having an embedded SDK with an NFC (Near Field Communication) component, a tablet or other hand held device, as well as a service station or point of sale (POS) having a dedicated program that does not require a browser, merely any Internet connection, in order to perform operations on the object. Operations on the object can be performed using a card reader (e.g., EMV (Europay, Mastercard and VISA) chip) or an NFC component, or other suitable device. The user interface for performing operations on the object is Web based and/or includes an application that supports various browsers and operating systems.

Since, at present, one cannot access PC/SC card readers directly from Java Script (JS) that runs in the browser, it is necessary to use a hybrid solution that combines JS Web code with additional code in a different technology, in order to fulfill all the requirements of the system.

The central management unit of the invention permits an end user to perform operations on a smart object from an end user station by means of an SDK that is embedded in the host (end user station). According to an exemplary embodiment, the SDK can be supplied as an Android library. In order to perform operations, the SDK contacts the central management unit (remote loading service) in a secure manner, for example, by means of a Secure Web Socket. The SDK provides several services—scanning the object to read what is inside, loading new data onto the object, erasing old data, locking the object, updating data on the object, sending instructions to be carried out by the object, etc. In addition, relevant permissions (such as permission for the cellular phone to communicate with the smart object reader) must be added to the host application.

The remote management unit provides access to all the data owned by the service provider by means of a standard Application Programming Interface (API) on Hypertext Transfer Protocol (HTTP). Connection to the interface is created using secure tokens (described below) that are created individually for each service provider by the management service.

Some terms used in this application will now be defined. “Remote loading service” is the management of requests for performing remote operations. “SAM (Secure Access Module) service” is a service that mediates between the end user station and an encryption device. “Service provider” is a company providing a service to an end user, for example, a bus company, a train management company, other public transportation provider, or any other company using smart card-type contracts. “Central management unit” is the service that runs the operations system (e.g., Internet web site, remote server, etc.). The central management unit can provide operation services for a number of service providers. “SDK” is a dumb component embedded in the system of the user interface that permits implementation of the various operations in connection with the SAM service. The SDK functions to transfer data from the smart object to the central management unit and to transfer queries or instructions from the central management unit to the smart object. It does not need to understand the data transmitted from the smart object, merely to implement instructions received from the central management unit for handling the data.

An exemplary embodiment of the invention includes installing a program on the computing platform of the end user. This program runs in the background (with no user interface), communicates with the application and/or Java Script in the browser, provides updates of the status of the card reader or corresponding device, and performs operations in coordination with the object reader/writer, as required. As a non-limiting example, the program can be developed in Java in order to permit easy compatibility with Mac OS X and compatibility with the Android SDK code, that performs a similar function, as well as compatibility with a broad range of different platforms.

Communication between the local program and the browser preferably is implemented by means of a PROXY service to which both parties will connect (for example, on the basis of a common security key) and communication will be implemented through the PROXY.

The local process can implemented, for example, by means of a Custom URL Protocol handler that can be activated by a link in the browser, or as a Windows service (or the parallel process in OS X).

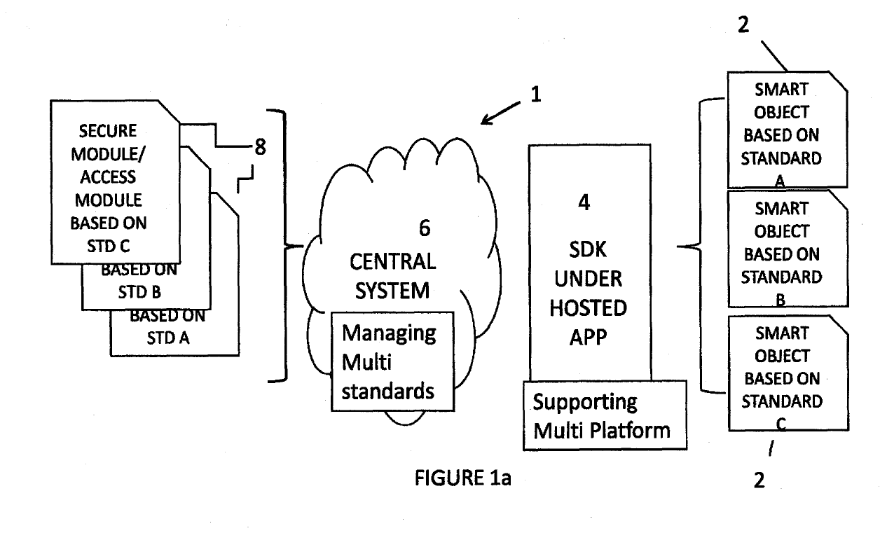

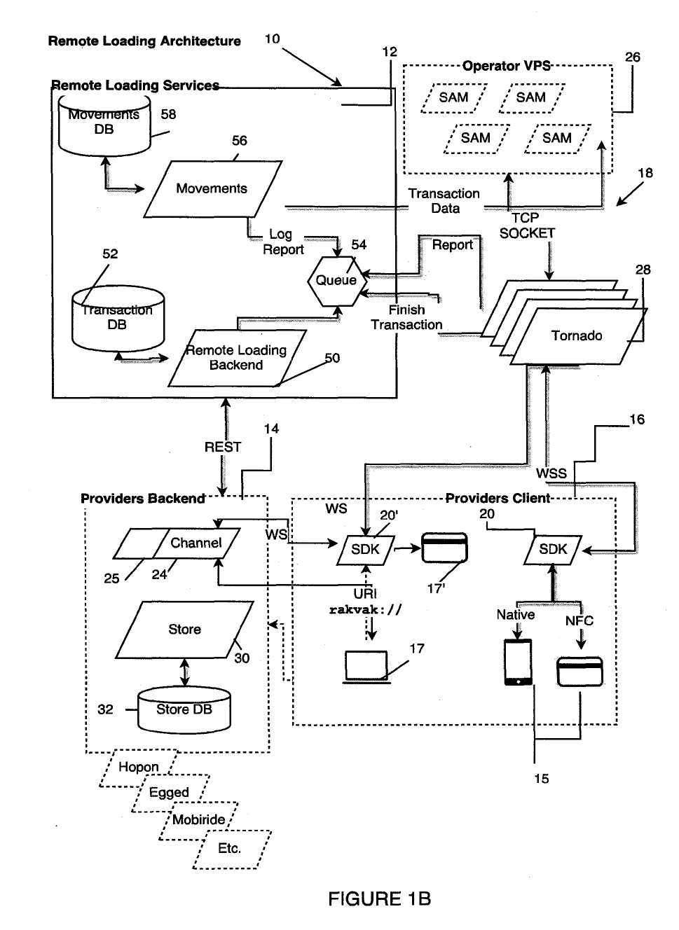

Referring now to FIG. 1a, there is shown a schematic illustration of the system 1 and method of the present invention. The system 1 includes a central management unit 6, preferably disposed in the Cloud, that manages smart objects and smart object readers of multiple standards (communication protocols), and a plurality of smart objects 2 based on the same or different standards. For example, one of three smart objects 2 can be based on each of standard A, standard B and standard C. A dumb SDK 4 is provided under a hosted application in the smart object reader/writer associated with each of the smart objects. The SDKs 4 are in communication with the central management system 6. The SDK supports multi-platform communication. The central management system 6 is in communication with a plurality of secure access modules 8, each of which is based on a different standard. In this way, the central management system can receive a suitable key for each smart object reader/writer according to the standard of its associated smart object.

Overall operation begins when a smart object is introduced into or placed in proximity to a smart object reader/writer (not shown). An SDK 4 in the host application of the reader/writer asks the central management system 6 for initialization. The central management system 6 identifies the standard or communication protocol of the smart object and requests a key from the SAM (Secure Access Module) 8 corresponding to the identified standard of the object. The SAM 8 preferably authenticates the object 2 by means of a physical key, for example, using a public key and a private key. Once the object has been authenticated, the central management system opens a communication channel between the SDK and the smart object and instructs the SDK which communication protocol should be used when performing operations on that smart object. The central management system 6 manages the various transactions and operations by sending a series of instructions to the SDK including what to ask or instruct the smart object at each stage. In this way, a single central management system can control the authentication and operation of a plurality of smart objects running any one of multiple standards and over any one of multiple platforms by means of a plurality of “dumb” SDKs performing operations on the smart objects. It will be appreciated that this system arrangement permits these operations to be conducted simultaneously on a plurality of smart objects. Use of secure access for communications enables communication through the cloud with a strong security mechanism.

With reference to FIG. 1b, there is shown a block diagram illustration of an architecture 10 for a system for performing operations on a smart object, constructed and operative in accordance with embodiments of the present invention. Architecture 10 includes a remote loading service or central management unit 12, typically disposed in the Cloud. The central management unit 12 communicates with, and operates over, a provider's backend 14, and over a communication channel 24, a provider's client 16, and an encryption unit 26.

Central management unit 12 includes a remote loading backend 50 coupled to a transaction database 52 wherein details of each transaction are stored. Backend 50 is also coupled to a queue 54 of transactions to be handled. Queue 54 is also coupled to a movements server 56 that sends it log reports. A movements database 58 is coupled to the movements server.

In the illustrated embodiment, central management unit 12 includes all the components necessary to manage the various services provided remotely by the management system, except for creating a connection between the browser and the host, which is performed by encrypted communication unit 18. Communication unit 18 includes a plurality of secure encryption units 26, here shown as SAM server, and a web services managing server 28, here illustrated as a Tornado server. The SAM server 26 is a remote service providing robust authentication, through which all transactions to the smart object are performed securely. Tornado server 28 implements the operation process and is responsible for managing and creating the secure communication connection between the encryption component (SAM) 26 and the SDK 20 that is embedded in the end user host device. Tornado server 28 is also coupled to queue 54 and sends reports regarding transactions to the remote loading backend 50 for storage in the transaction database 52. Preferably, central management unit 12 is coupled remotely to the SAM server 26 for transferring movements data, when required.

The Provider's Backend 14 is a backend server of the service provider or store manager that sells the services that will be provided by the service provider. Store 30 is the backend server of the store and is coupled to a store database 32. The end users purchase contracts for these services and these contracts are loaded on their respective smart objects. Records of the contracts of each service provider purchased by end users are stored in its store database 32. Communication with the central management unit 12 is accomplished by means of a communication channel 24 using representational state transfer (REST). Communication channel 24 includes a data model server 25 and the channel 24 may include a proxy server (not shown).

The Provider's Client 16 is the end user (smart object reader/writer) of each service provider. There are two main groups of end users—those 15, such as smart phones, having NFC capabilities or native communication with smart objects, that can communicate directly over the Internet, and those 17, such as personal computers with attached smart object readers/writers 17′, that cannot communicate directly over the Internet, typically due to security issues. In the case of devices that can communicate over the Internet, a “dumb” SDK 20 is embedded in the device 15 and can communicate with the central management unit 12 over a secure Web socket 27 created by the Tornado server 28.

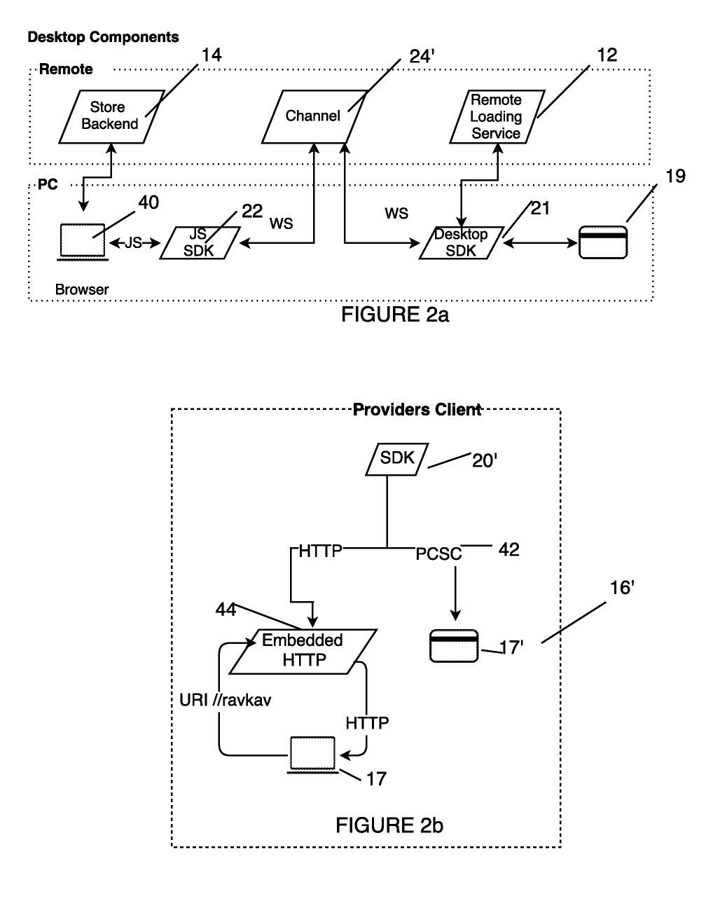

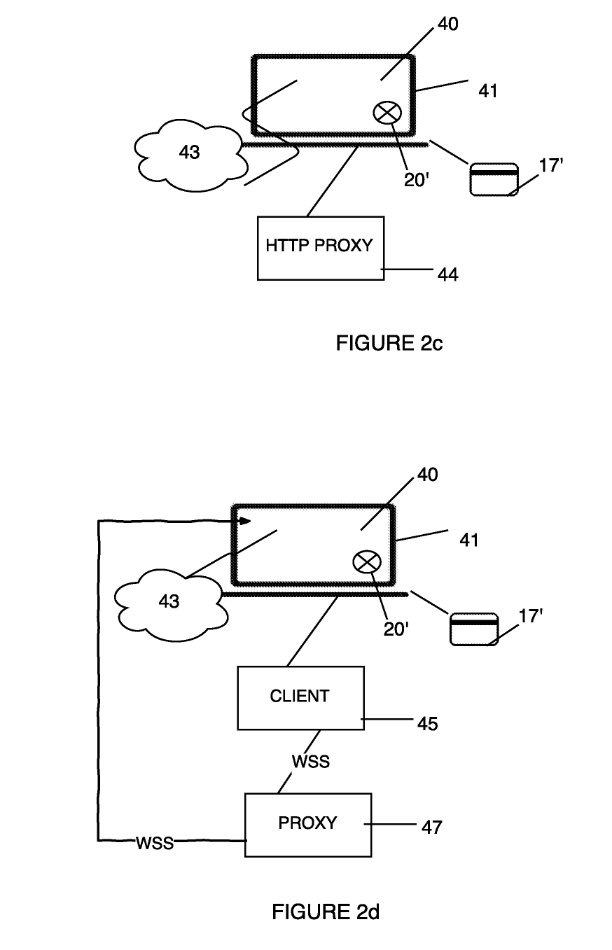

Implementation on a personal computer (PC) 19 and on a POS device, is shown in FIGS. 2a and 2b, in schematic and block diagram form, respectively. The Provider's Client 16′ includes a browser 40 (for the personal computer implementation), such as Explorer, Chrome, Safari and Firefox. The store backend 14 communicates with the PC through the browser 40. A dedicated card reader/writer component 17′ (for example, using PC/SC 42 to access the smart object) is coupled to the computer, as via a USB.

In this embodiment, the SDK 20′ is divided into two SDKs which “chat” via a proxy. For the sake of security, the smart object is not permitted to communicate directly with the browser in the PC, so SDK 20′ is split into a desktop SDK 21 coupled to the object reader and a Java Script (JS) SDK 22 coupled to the browser in the PC 40. It will be appreciated that the JS SDK is only one example of a browser SDK and they will be used interchangeably in this application. SDK 21 is installed on the end user's computing platform and manages the local process that is installed on the computing platform of the end user. The JS SDK 22 is a Java script code used by the provider website to communicate with the Desktop SDK and can be embedded in the web sites of the various service providers. Communication channel 24′ includes a proxy server (not shown) between the two. Communication channel 24′ is configured to implement communication between the desktop SDK 21 and the Web. In the illustrated embodiment, this is accomplished by creating two Web Socket connections (on the basis of a common encryption key), one between the desktop SDK 21 and the communication channel 24′ and the second between the JS SDK 22 and the communication channel 24′, to permit transfer of data from one to the other. The JS SDK can display the state of the connection.

As illustrated in FIG. 2b, the Provider's Client also includes a software module including two components which are distributed and installed together, but are independent of one another. One component is the SDK 20′, which is responsible for performing operations in connection with the read/write component and creating communication by means of the web services managing server (here, the Tornado server). The SDK 20′ is an independent component supplying an application programming interface (API) only through direct execution by the host operating system. The SDK acts as a sort of Remote Procedure Call (RPC) service, and its functions are implementation of the Tornado server protocol, as follows:
a) Transfer of APDU instructions (an application protocol data unit (APDU) is the communication unit between a smart object reader/writer and a smart object) which are sent by the Tornado server;
b) Execution of the instructions in respect of the smart object;
c) Sending responses back to the Tornado server for further processing;
d) Indicating the end of the process and sending back a response accordingly;
e) Basic indications in respect of the status of the read/write component—e.g., whether the reader is connected, whether the object is in the reader, etc.

The second software component is an embedded HTTP server 44. HTTP server 44 is responsible for transferring messages from the browser 40 (which is running on the PC 17) to the SDK 20′. This component executes HTTP server on the local host via a pre-set port and receives requests through standard HTTP protocol. The functions of this component are as follows:
1) Authentication of the identity of the user requesting the service.
2) Transfer of messages from the browser to the SDK server.
3) The user will initiate operation of the component through the browser by use of custom URI schema. Use of URI schema permits, during installation, registration of the operating software in the personal computer at the time of installation using a particular link. Use of URI schema permits:
   1) Running a program on a personal computer by clicking on a link in the browser;
   2) Transfer of data (by means of the URI address) to the program running on the personal computer;
   3) Running a program on the computer directly from the browser without requiring continuous operation of the program.
   4) To confirm that the program is running on the computer where the browser is running.

Preferably, the SDK and the Embedded HTTP server are constructed separately so that the SDK can be supplied without the HTTP server to service stations and POS stations.

FIGS. 2c and 2d illustrate two options of data paths when loading a smart object using a PC having a browser. As shown in FIG. 2c, browser 40 has access to the World Wide Web 43 over the Internet but has no access to any other component of the PC, so it cannot communicate directly with the smart object reader 17′ coupled to PC 41. The PC 41, itself, communicates with the smart object reader 17′ as over a USB cable. The PC 41 has two embedded SDKs (here shown schematically as SDK 20′). The first data path is substantially as shown in FIG. 2c. In this case, an HTTP proxy server 44 is provided in the PC local port which can communicate with both SDK 20′ and browser 40. This option is less desirable as it is also possible for data on the PC to be accessed from outside the PC via the Internet.

The preferred embodiment shown in FIG. 2d includes an external client program 45 connected to SDK 20′. External client program 45 is also connected to a proxy server 47, which is in communication with browser 40 by means of secure two-way communications, for example a secure Web Socket. This data path is preferred because only the browser contacts the Web. The proxy only contacts the browser and the client. Thus, no data from the PC can be accessed from the Web.

According to exemplary embodiments of the invention, communication is provided by four main components: an SDK 20 embedded in a host user interface (provider's client), a communication channel 24, a SAM (Secure Access Module) server 26 and a web services managing server 28. It will be appreciated that the SDK is a generic SDK. In other words, the SDK for each end user interface includes the same code, only having a different communication protocol or channel, according to the host.

A method for performing operations using an application in a smart cellular telephone having an NFC (Near Field Communication) reader is as follows, by way of non-limiting example only. 1. The central management unit requests from the SAM service a unique key to perform operations regarding a particular contract and card. Preferably, the key is a physical key, which is part of the SAM server, which may, itself, be part of the central management unit. 2. The SAM server sends the key to the central management unit to carry out the operations. Preferably, the key is valid for a limited period of time, for example, sixty seconds. 3. The central management unit transfers the key that it received to the local SDK in the host. 4. The SDK decrypts the key, extracts from it an address of the endpoint of a secure web socket, or other secure two-way communication, and opens a communication channel. 5. As soon as the communication channel is open, the SAM server authenticates the request (using the most stringent available authentication) and begins to send instructions to the SDK. 6. The SDK receives the instructions and transfers them to the smart object reader/writer for implementation. Upon implementation, or error, an appropriate message is sent from the smart object reader/writer to the SDK, which transfers it directly to the central management unit. 7. The structure of the instructions can be JSON (JavaScript Object Notation), XML, or any other suitable structure. 8. The process is ended by the SDK when a completion message is received from the central management unit or if the connection is broken suddenly. 9. When the process ends in an orderly fashion, the SDK will execute the relevant CALLBACK function, either success or failure, and will provide a completion code and the causes or arguments from the Server. 10. In case of unexpected failure of the process, the SDK will execute a protocol for unsuccessful performance of the operation. 11. The results of the transaction are recorded in the transaction database.

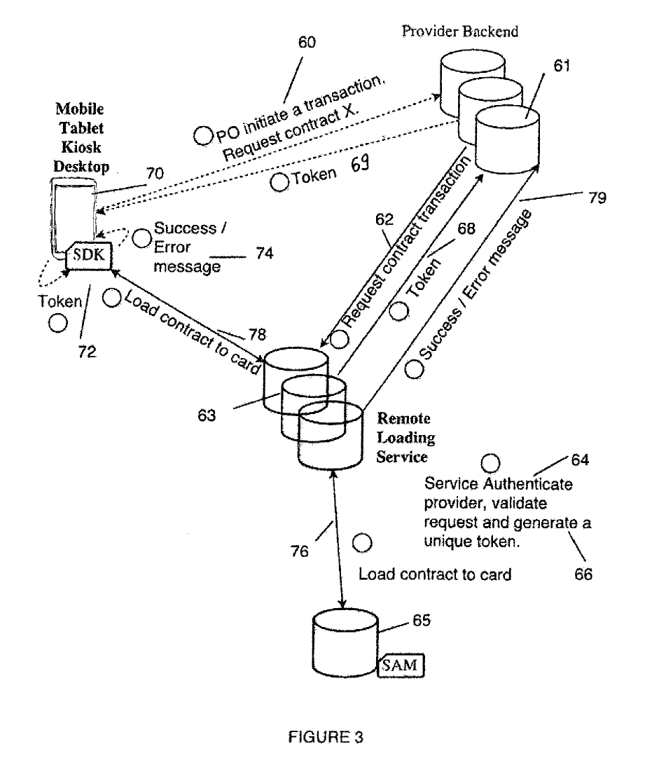

A method for loading data on a smart object representing a transaction using a browser and a card reader/writer, according to embodiments of the invention, is illustrated schematically in FIG. 3, by way of non-limiting example, only. The method is as follows: 1) The SDK software component 72 is installed on the host computer 70. 2) The user initiates a transaction 60, e.g., chooses a contract for loading to the card, and inputs his payment details. 3) The backend server of the service provider requests 62 a transaction from the central management unit (the remote loading service), and requests authentication. The central management unit will authenticate 64 the service provider and validate the request. It will then generate a unique token or key 66 using the SAM service or other authentication server. The token indicating grant of permission for the requested transaction is transferred 68 to the provider backend, which then provides the token 69 to the SDK 72 of the end user (host). 4) The end user device displays a link on the display screen with the relevant URI schema to conduct the transaction. 5) After the user clicks on the link, a web browser page will be displayed to the user asking whether to run the application associated with that URI. 6) The choice of “Launch Application” will activate the Embedded HTTP Server component or the SDK 72, which will check for available contracts or updates with the SAM server of the service provider and, if any exist, will download them 76 to the central management unit which will indicate to the end user which updates are available. 8) The SDK component will activate the HTTP server and listen on the pre-selected port. 9) No indication need be provided to the user during this process. 10) In parallel, or after clicking on another link, the browser will connect via the relevant port. 11) If the connection is successful, the host computer can now communicate with the central management unit via the browser. 12) After determining that both sides are connected, the token for performing the transaction will be transferred from the HTTP server to the component in the SDK to perform the transaction. If the card is not connected, an indication 74 is provided, as by means of an error message from a component in the SDK, which is transferred to the browser in the host for display to the user. If the card reader is not connected, an indication must be provided in the same fashion. If all connections are in place, the central management unit will send instructions to load 78 the contract to the card. 13) When loading to the card is complete, the SDK component will provide a suitable message to the HTTP component and to the central management unit. 14) The HTTP component will return a suitable message to the browser to be displayed to the user. 15) The central management unit will send 79 a success or error message to the provider backend to update its database. 16) At the end of the process, the HTTP server will stop running and shut down.

The loading of added value (a new contract) to a smart card by an on-line system, according to embodiments of the invention, is as follows. 1) The end user browses in his or her browser to the store site of the service provider of interest, for example, a bus or train company, while the browser runs the Web SDK. 2) The Web creates a random key and connects to the proxy server, as by opening a Web Socket to the appropriate IP address. 3) The store displays a link “to connect to the card reader”. By clicking on the link, the user opens the appropriate page and the browser displays the suggestion to run the Desktop program installed on the computing platform.

4) The Desktop program runs and receives, as a parameter, the address of the Proxy. 5) The Desktop program opens a Web socket to the address it received and the Proxy notifies the two sides when a successful connection has been created. 6) The Desktop program sends to the Web updates regarding the state of the card reader (connected, disconnected, no card, error), and the Web program displays instructions to the user, accordingly.

7) When the reader is coupled and the card is inside the reader, the Web program sends to the Desktop program a request to perform a Dump to the card (display its contents). This is implemented by a SAMSERVER request, in which it also transfers the URL of the SAM server, with which the dump transaction must be performed. 8) The Desktop SDK opens the Web Socket to the address it received, and performs the transaction. During the transaction, the SAM server sends APDU instructions. The Desktop SDK sends them to the card reader and returns its answers to the server. At the end of the process, a JSON or XML result is received and it is transferred from the Desktop SDK to the Web SDK.

9) The store displays the contents of the user's card, and permits the user to select a new contract or transaction for loading. 10) The user selects a contract, inputs payment details and the store updates the SAM server (behind the scenes) of the details of the desired transaction. Then, the Web SDK sends to the Desktop SDK a SAMSERVER request, similar to that described above in step 7, with the URL of the transaction. 11) The Desktop opens a new connection with the SAM and performs the transaction (as described above in step 8.) (From its point of view, there is no difference between a dump transaction and a loading transaction.) 12) The store updates the user that the operation has been completed successfully and the payment was received.

One non-limiting example of the internal architecture of a Desktop SDK as shown in FIG. 2a will now be described. The Desktop SDK includes a DesktopProcess. This is the main process that is responsible for activation of all the internal components, the connection between them and a Tray Icon display. It also includes a WebSDKConnector—a process that is responsible for the connection to the Proxy and all the communication opposite the Web SDK. In addition, it includes a LoadManager, the process that is responsible for the connection to the SAM and implementation of the transaction, including accessing the card reader. Finally, it also includes a CardObserver—a process responsible for examining the state of the card reader and updating the remaining processes.

Its operation can be as follows. 1) The Web SDK runs the Desktop SDK by means of a URL protocol handler. 2) The DesktopProcess is activated, initializes the CardObserver and WebSDKConnector processes that are running in the background. 3) The WebSDKConnector opens a WebSocket or other secure two-way communication connection to the proxy, sends updates of changes to the status of the card reader and waits to receive comments from the Web via the proxy. 4) The CardObserver samples the state of the card reader every few seconds (e.g., in order to find a suitable card reader and/or to check whether a card is inside). 5) The CardObserver updates the WebSDKConnector of each change in the state of the card reader. 6) The WebSDKConnector receives a SAMSERVER request and activates the LoadManager. 7) The LoadManager performs the transaction in the WebSocket opposite the SAM server. 8) Instructions received from the SAM are sent to the card reader.

The present invention includes a novel combination of four main elements. First is the SDK, the dumb, generic software component that can be embedded in the host system (substantially any technological platform) and can work with smart objects by means of remote secured components. The solution includes unique SDK solutions for mobile phones, tablets and the like, as well as a unique solution for desktops, personal computers, POS stations and so on. Second is work with a Proxy server, where necessary, which permits performing operations using any Internet browser on any operating system. Third is the management system, which is flexible in the services it provides, associating public transportation operators, government offices responsible for public transportation, with specific encryption keys and several distributors (i.e., stores, web sites) or platforms. In this way, both the service provider and external stores can sell the service provider's contracts and add value to the smart objects, using the unique keys of the service provider. Thus, the invention is both flexible and scalable. Fourth is the backend—the server and the application of the central management unit, that manages the process and the communication with the end stations, including the SDKs.

The present invention also relates to a method for creating or updating a user's profile on a smart object, such as a smart card or electronic transportation card. One application for which the invention is particularly suitable is reading from and recording to smart cards in order to personalize the cards used by students as tickets for public transportation. In addition, this invention can be used to create or personalize in any fashion an end user's profile, including indicating special benefits due the user from various service providers.

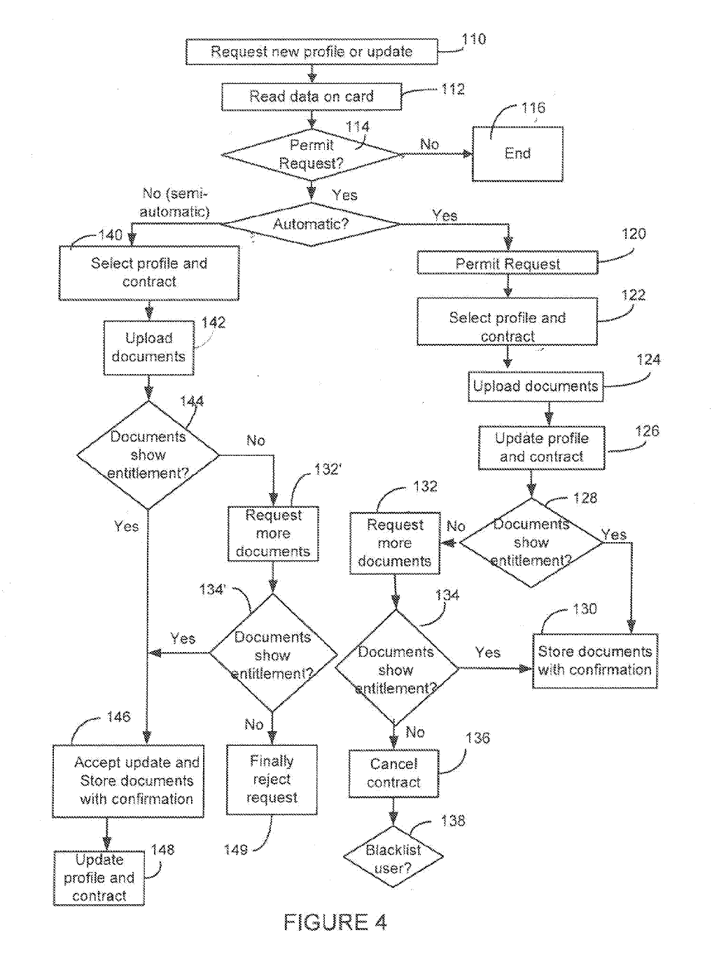

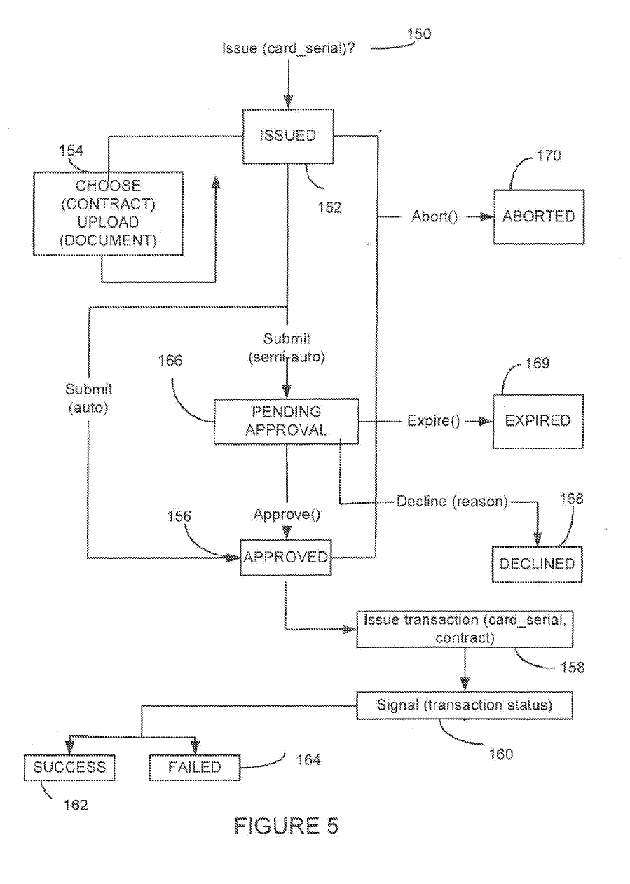

Referring now to FIG. 4, there is shown a flow chart illustrating a method of remotely creating or updating a profile on a smart object according to some embodiments of the invention. This embodiment is described herein with relation to remote updating of student status on a smart object on which student status was recorded in a previous school year, although it can also be applied to the creation or updating of any profile on a smart object. For purposes of this invention, a profile refers to characteristics of the object's end user that permit him or her to enjoy special terms or special conditions. This can include student status, senior citizen status, a handicapped indication, and so forth. Recording these profile characteristics on a smart object at present is performed manually, so that at times like the start of a school year, there is a very long waiting line at a cashier for updating or creation of a profile. The present invention provides several options for remotely implementing automatic and semi-automatic creation, extension and alteration of end user profiles. The automatic or semi-automatic implementation typically is selected by the service provider or a regulatory body.

The process begins with the user filing online a request for creation of a new profile or updating an existing profile (block 110). In the case of a returning student, the end user requests, online to the server, an extension of student status, including a statement that his student status is extended for another year. The object reader in the system (described in detail below) reads the data which is already recorded on the card (smart object) (block 112) in order to determine whether or not to permit consideration of the request (block 114). If the request is not permitted, for example, because the data on the card does not confirm that the user was a student in the previous year, the transaction ends (block 116). If consideration of the request is permitted (block 120), for example, if the data on the card confirms that the user was a student in the previous year, one of two scenarios can follow, one automatic and the other semi-automatic. In the case of completely automatic processing, the user selects the profile currently requested and, preferably, also selects a new contract to purchase simultaneously with loading the profile into the smart object (block 122). The end user is now requested to scan and upload documents, or provide links to external databases holding the necessary documents, proving his or her current status (block 124). Based on the information in the smart object and the statement of the end user, the request to update status is accepted automatically and the server updates the user's profile and contract on the smart object (block 126).

It will be appreciated that, in this scenario, the documents uploaded to the server are not reviewed by a human being at this stage. Rather, these documents are stored in the system server together with the end user's other personal profile details. Preferably, at least some of the documents are also stored on the smart object for ease of accessing by a conductor or clerk. Alternatively, or in addition, the necessary documents that prove entitlement to the requested profile may be stored in an external database that is accessible by the service provider's computing system for viewing and verification, when required. At any time when it is desired to confirm that the end user is, indeed, entitled to this status, the uploaded documents are reviewed (block 128) and accepted or rejected. If the documents are accepted, the documents are stored with confirmation that they passed review and the status remains as updated in the smart object (block 130). If the documents are rejected, a request for more documents is preferably given to the user (block 132). The server again checks whether the newly uploaded documents are satisfactory (block 134). In this way, the user can be given a number of chances to upload documents that indicate his entitlement to the profile. If none of the documents is satisfactory to shown entitlement, the contract in the smart object is canceled (block 136) and a decision will be made as to whether to black list the user (block 138). In this case, the money paid for the additional contract is forfeited by the end user.

The actual sufficiency of the uploaded documents to prove entitlement to the requested status can be checked by a conductor or bus driver (in the case of public transportation) or by a guard at the entrance to a university, or by a clerk of the service provider, who conducts random checks among those requesting profiles. Typically, this is performed manually, and the user's documents, both information on the card and that available from the server database and/or from external databases, are reviewed and verified, as stated above.

As stated above, in order to reduce the temptation of fraud, the end user is required to purchase an additional contract simultaneously with updating his or her status. In this way, the end user knows in advance that he or she will forfeit the cost of the additional contract, should fraud be uncovered. Thus, simultaneously with updating the profile in the smart object, the system will also update the purchased contracts, all in one single automatic operation.

Alternatively, the updating process can be semi-automatic. In this case also, the user selects the profile currently requested and, preferably, also selects a new contract to purchase simultaneously with loading the profile into the smart object (block 140). The end user is now requested to scan and upload documents, or provide links to external databases holding those documents, proving his or her current status (block 142). A human clerk reviews the new material together with the data recorded on the smart object, and any information available about the user on the system server or on accessible external databases, and decides (block 144) whether or not the documents show the user's entitlement to the requested profile (e.g., to grant the request for an extension of student status). As in the totally automatic case, if the documents are rejected, a request for more documents preferably is given to the user (block 132′). The clerk again checks whether the newly uploaded documents are satisfactory (block 134′). If none of the documents is satisfactory to show entitlement, the request to load a profile on the card will be finally denied (block 149).

On the other hand, if the documents are accepted as showing entitlement, i.e., if the profile or extension is granted, the new documents are stored in the server and, optionally, on the smart object (block 146). The server now updates the profile and contract in the smart object (block 148). Since the documents have passed a human review, it will be possible, but not required, to purchase a new contract at the time of loading the new or updated profile.

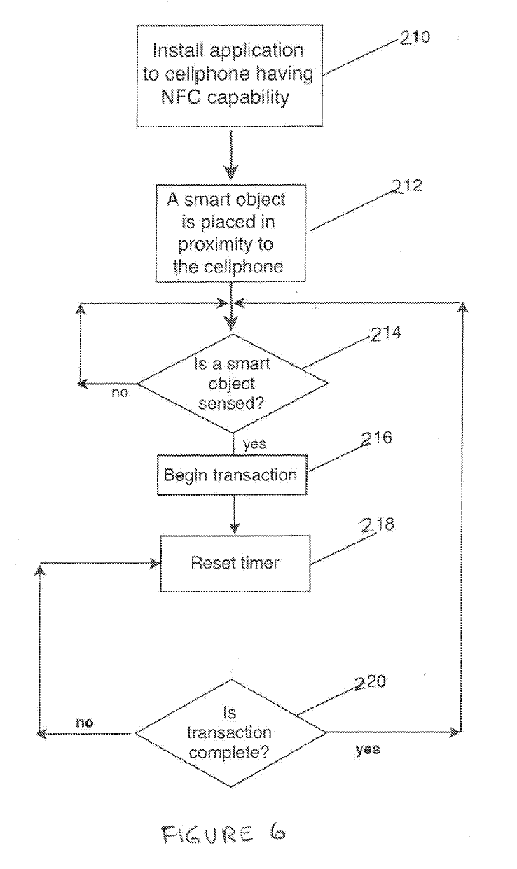

An overview of an automatic procedure, according to embodiments of the invention, is set forth in FIG. 5, a block diagram illustration of the update process. In this method, a user requests personalization (recording of personal characteristics) of a smart card or other smart object (block 150). The server issues the card (block 152) for which personalization has been requested and waits to receive corroborating documents. The end user chooses a new contract and uploads his or her documents or indicates where such documents can be found in accessible external databases (block 154). The current documents together with data read from the card are stored in the server for review and approval. In a completely automatic procedure, the server automatically approves the request (block 156). That is, the documents are approved and the user is granted the requested contract and profile without any review of the documents. The contract and status are updated on the card (block 158) and a signal indicating the transaction status (block 160) can be sent to the user, for example, the transaction was completed successfully (block 160) or the request definitively failed (block 162).

In a semi-automatic process, the current documents together with data read from the card are submitted online and the user is awaiting approval (block 166). A clerk reviews the documents and either declines the request (block 168) (i.e., the documents are declined, the user is not entitled to the requested contracts and profile) or approves the request (block 156) (i.e., the documents are approved and the user is entitled to the requested contracts and profile). If the time pending approval extends beyond a pre-selected time period (i.e., the request was inactive for X amount of time), and/or the user attempts to update more than a pre-set number of trials, the request expires (block 169) and further update attempts are blocked at that time. Thus, the end user will have to begin the procedure from the beginning.

It will be appreciated that the request to load or update a profile and contract can be aborted at any time (block 170) by the end user.

Occasionally, a user will request to cancel his or her contract and receive a refund of the unused value. This operation can also be performed remotely using the system of the present invention. In this case, the smart object will be authenticated, as described above, and the requested action will be cancellation. The central management unit will first confirm in the transaction database (or with the provider backend) that a contract was, indeed, purchased and that payment was received. If so, it will then ask the SDK to dump the data on the card so as to determine the unused value remaining on the smart object from that contract. Once the contract to be canceled is found, the central management unit will request a token (key) from the secure access module and open a secure communication line with the object reader/writer. The central management unit will send instructions via the SDK to the smart object reader/writer to delete the contract from the smart object. When the cancellation is confirmed as being successful, the provider backend will refund the remaining value to the credit card account of the user from which the contract was purchased, in any known manner.

As stated above, the methods of loading and personalizing a smart object as described above can be implemented using a smart phone with NFC capabilities. However, not all Android smart phones can be utilized at present due to the difficulty of performing Discovery. It is known that cellphones utilizing an Android operating system cannot communicate with, and perform operations on, Proximity Cards (smart cards operating under NFC technology that are held in proximity to the cellular phone) which are subject to the communication standard (protocol) set forth in ISO/IEC 14443 A/B, etc. This problem stems from the non-standard Discovery process in the Android operating systems, which causes the phones to crash when trying to communicate with a specific proximity card. These cards are described in detail at https://en.wikipedia.org/wiki/ISO/IEC_14443. ISO/IEC 14443 is an international standard that defines proximity cards, contactless integrated circuit cards used for identification, and the transmission protocols for communicating with them. There exist many loadable smart cards used, for example, for pre-paid transportation tickets, that operate according to this standard, for example, German identity cards, MIFARE cards, and so forth.

The layers of NFC communication as defined in the standard are as follows:

ISO7816-4:
Card organization and structure
ISO14443-4:
Transmission protocol
ISO14443-3 type A:
Activation & Anti-collision
ISO14443-2:
RF signal interface
ISO14443-1:
Physical layer

The relevant portions of these layers for reading and writing communication with a proximity card are:

Layers 1 and 2—infrastructure layers;

Layer 3—which embodies the NFC-B on the smart card. This layer defines the type of technology—i.e., whether it is NFC-A or NFC-B, and so forth.

Layer 4—implements the ISODEP on the smart card that defines the data transfer protocol.

Layer 5—defines the arrangement of the data on the card and is implemented in a unit called an APDU—Application Protocol Data Unit. Only APDU frames that were defined according to the standard are required to be identical for all devices and versions of the Android operating system.

What is expected from the system while communicating with smart cards is as follows. The action that is supposed to take place is a Discovery process, which is accomplished by sending a special data block from the phone to the card and receiving a different special data block in return from the card. This return data block is part of layers 3 and 4 above. Once this block is received, actual reading from and writing to the card will take place by means of the APDU blocks, as defined in layer 5. However, in Google, layer 5 is used to perform Discovery. Certain smart cards, for example, Mifare, support performance of Discovery in level 5. Unfortunately, many other cards do not support this implementation of the Discovery process. Accordingly, what happens in practice is the following. It can be seen in the source code of the Android operating system (OS) that the OS uses APDU blocks from level 5 in order to perform the Discovery process. Since this is contrary to the instructions of the standard according to which NFC cards are produced and utilized, many smart cards are not able to complete the Discovery process when performed in this manner. In the Android code, there is a Class named WatchDog whose job is to check every 125 ms to confirm that the card is still within range of the phone. Ordinarily, this check is performed using the data block mentioned above from layers 3-4. However, since this block does not exist, but instead is an APDU frame from layer 5, the Discovery process disconnects the existing communication channel and causes the clock to “reset”, i.e., restart the time count from zero, thereby beginning the Discovery process again. Performing operations on the card cannot be accomplished in this short amount of time. This means that, for smart cards and phones that do not support this ability to perform Discovery in layer 5, Discovery fails and communication sessions with the card end after only 125 milliseconds and the application crashes.

According to alternative embodiments of the present invention, there is provided a method for creating and maintaining a communication channel between a smart card or other smart object and a smart cellular processing device, typically a telephone or tablet, having an NFC (Near Field Communication) component, running an Android Operating System (OS) that does not support performing Discovery using a Layer 5 APDU, in order to perform remote operations on the card. This is accomplished by delaying the time at which Discovery signals are sent from the smart device to the card. For ease of description only, this portion of the invention is described hereinbelow with regard to a smart card.

One method of implementation is to perform an operation whose object is to make the Discovery process transparent for the smart card, as is the case when following the standard. This method includes the use of Java Reflections, which permits the phone to skip the usual API of each Java object and gain access also to the functions and fields that are Private, without changing them (which would require Root, etc.)

The timer in the operating system typically counts down 125 ms before sending a next Discovery signal. According to this embodiment, a module of the application will repeatedly reset the timer before it reaches the pre-set time delay, so as to reach the total desired delay interval to permit performance of a transaction. In this way, if the timer is reset continually when the transaction is still in process, possibly at pre-selected time intervals for a pre-defined number of resets, it is possible to control, precisely, when the Android OS will perform the Discovery process with the card. In this way, the internal timer of the Android operating system can be circumvented, preventing cutting short the communication between the cellular phone and the card. This circumvention is synchronized with performance of the transaction, so that, when the desired transaction is completed, the application ceases resetting the timer. This method is particularly appropriate for the Android Operating System, Versions 4.3 and lower.

Another method of implementation includes control, by the application, of the Discovery process when the NFC of the cellular phone is in the Reader Mode mechanism. This is accomplished by defining a time delay interval before the sending of a Discovery request, once a smart card is detected in proximity to the cellular phone. This mechanism is available in Android OS versions 4.4 and above. According to one embodiment, this can be implemented as follows. When the application becomes operative, the NFC is activated directly in Reader Mode with X millisec delay in sending a Discovery signal (where X is short, e.g., about 125 ms). The first time that the card is detected, the application implements a time delay for Y seconds, which is long relative to X, typically the time required to perform a transaction, for example, 10 sec. When communication ceases (i.e., the transaction is completed successfully), the application switches back to the short delay time. The application blocks the tones and ignores the card. This change prevents the NFC service from crashing and allows continuous communication with the card, permitting reading from and writing on the card when this application is applied.

The application includes a global variable, which indicates whether there is data to be read on the card and, if not, then the tones are deactivated. When a screen is reached that must be read, the tones are activated again.

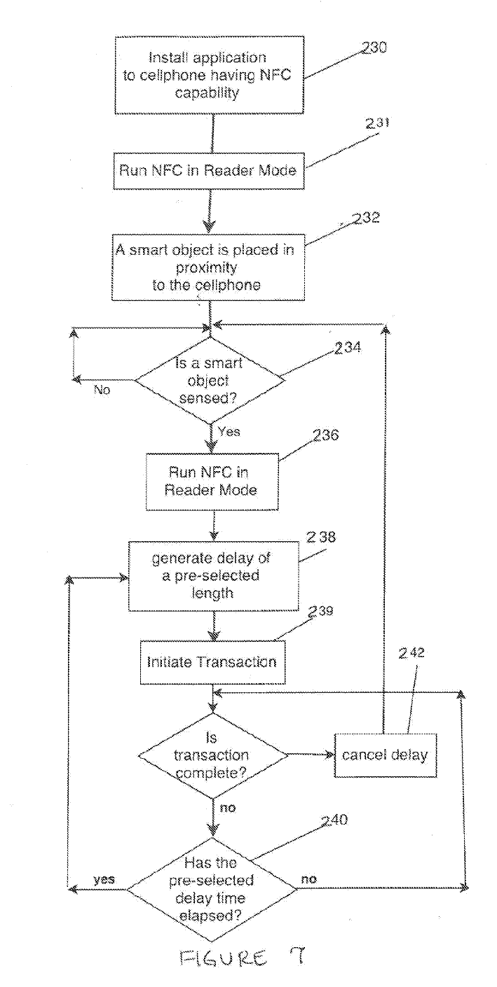

With reference to FIG. 6, there is shown a flow chart of an exemplary method for creating communication between a smart object and a smart cellular phone, operative in accordance with embodiments of the present invention. The created communication permits the cellular phone to perform operations on the smart object, such as writing thereon. An exemplary embodiment of the invention includes installing a program (software module or application) on the computing platform of the end user that runs in the background (with no user interface), communicates with a chip or processor in the smart object, provides updates of the status of the corresponding device, and performs operations opposite the card reader, as required.

This exemplary method for creating a stable communication channel to perform a transaction on a smart object using an application in a smart cellular telephone running Android 4.3 and below as its operating system and having an NFC (Near Field Communication) reader is as follows, by way of non-limiting example only. 1) The communication software component is installed on the cellular telephone (block 210). 2) A user places a smart object in contact with or in close proximity to the cellular telephone (block 212). 3) The NFC of the cellphone detects the presence of the smart object (block 214) and runs the application of the present invention. 4) It is now possible to start a transaction (block 216) and reset the clock (return the count to zero) (block 218). 5) The application now checks whether the transaction has been completed (block 220). 6) If it has not, the application resets the timer (block 218). 7) If the transaction is complete, the cell phone reverts to the mode of waiting to sense a smart object (block 214).

It will be appreciated that the central management unit of the present invention can be used to manage smart objects in many countries at the same time. Each country will have its own secure encryption unit, according to local standards, and its own data model server providing the data display preferred in that country.

Referring now to FIG. 7, there is shown a flow chart of an exemplary method for creating communication between a smart object and a smart cellular phone, operative in accordance with alternative embodiments of the present invention. This embodiment is appropriate for cellular phones running Android 4.4 and above as their operating system, where the cellular phone can read from and write to smart cards. This is because the NFC Reader Mode is made available in these phones. Even phones that already had the capability to work with smart cards can be operated in this manner, as well as phones that do not have this capability, such as Nexus 5. The application allows the cellphone to switch between a usual mode, wherein the time delay before a Discovery signal is sent to identify the card that is in close proximity to the phone is 125 ms, and a communication mode, wherein the Discovery function is delayed in order to avoid automatic reset due to lack of identification, and provides continuous communication with the NFC in Reader Mode.

From the point of view of the host, the function (resetDiscovery) becomes operative. When the application runs this function, it delays the Discovery operation. As soon as a user places a card in proximity to the phone and the phone detects the card, the time delay is implemented and prevents the sending of a Discovery signal for the pre-selected time delay so that communication with the card can be successfully accomplished.

According to the embodiments of FIG. 7, the method for creating a stable communication channel to perform a transaction on a smart object using an application in a smart cellular telephone having an NFC (Near Field Communication) reader is as follows, by way of non-limiting example only. 1) The communication application is installed on the cellular telephone (block 230). 2) The application now opens the NFC chip in READER MODE with its usual short timeout (delay time before sending a Discovery signal) (block 231). 3) A user places a smart object in contact with or in close proximity to the cellular telephone (block 232). 4) If the cellphone does not detect the presence of the smart object (block 234), the phone remains in usual mode. 5) When the NFC detects the presence of the smart object (block 234), it is opened in the Reader Mode (block 236) with a longer timeout, as described above, to permit completion of the transaction, and runs the application of the present invention.

The application generates a delay time (timeout) of pre-selected length before the next Discovery signal is to be sent (block 238), whereby the phone enters the communication mode. In this mode, the communication channel remains open so as to permit performance of operations on the smart object by the cell phone. It is now possible to start a transaction (block 239).

The application checks whether the transaction has been completed (block 240). If so, it cancels the delay (block 242), returning the phone to its usual mode. If the transaction is not complete, the application checks whether the pre-selected delay time has elapsed. If it has elapsed, the application returns to (block 238) and generates an additional delay. If it has not, and the pre-selected delay time has not elapsed, the application and returns to (block 240) to determine whether the transaction is complete.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for performing an operation on a smart object, the system comprising:
at least one user interface, having access to the Internet, including a smart object reader/writer and a processor;
a universal, multi-platform “dumb” SDK (Software Development Kit), supporting multi-platform communication, embedded in each said user interface;
a central management unit disposed in the Cloud, configured to operate under multiple platforms and to communicate over multiple standards, in two-way communication with each smart object via its SDK;
at least one provider backend in communication with the at least one user interface and with the central management unit;
a secure encryption unit providing a key for each communication between each, said SDK and the central management unit; and
a web services managing server configured to provide secure two-way communication between each said at least one user interface, the secure encryption unit, the provider backend and the central management unit.

2. The system according to claim 1, wherein said key for each communication between each said SDK and the central management unit is a physical key;

3. The system according to claim 1, further comprising a proxy server to permit a user interface and central management unit, which use different communication protocols, to communicate with one another.

4. The system according to claim 1, wherein:
the user interface is a personal computer running an Internet browser and having an attached object reader/writer;
the SDK comprises two SDKs:
a desktop SDK installed on the personal computer; and
a browser SDK embedded in the provider backend and accessible via the PC;
wherein the desktop SDK and the browser SDK communicate with one another.

5. The system according to claim 4, wherein the desktop SDK and the browser SDK communicate with one another via a proxy.

6. The system according to claim 4, wherein a communication channel between the desktop SDK and the browser SDK includes two secure Web Socket connections, based on a common encryption key, one between the desktop SDK and the proxy and the second between the browser SDK and the proxy, to permit transfer of data between the desktop SDK and the browser SDK.

7. The system according to claim 1, wherein the provider backend is configured to perform operations on multiple smart objects simultaneously.

8. A method for performing an operation on a smart object, the method comprising:
initiating an operation on a smart object by a user interface having access to the Internet, the user interface including a smart object reader/writer and a processor;
requesting, in a backend server of a service provider having a provider database, a transaction and authentication from a central management unit disposed in the Cloud, configured to operate under multiple platforms and to communicate over multiple standards; after authentication, generating a unique key using a secure authentication server; transferring the key to the backend server and to a universal, multi-platform “dumb” SDK (Software Development Kit), supporting multi-platform communication, embedded in the user interface;
securely downloading available contracts from the service provider to the central management unit; and,
sending instructions by the central management unit to the SDK to load a selected contract to the smart object.

9. The method according to claim 8, further comprising:
when loading to the object is complete, providing an indication thereof by the SDK to the user interface and to the central management unit; and
sending, by the central management unit, a success or error message to the provider backend to update the provider database.

10. The method according to claim 8, further comprising, prior to the step of initiating:
detecting a smart object by a user interface;
requesting initialization from a central management unit, configured to operate under multiple platforms and to communicate over multiple standards, disposed in the Cloud, by a universal, multi-platform “dumb” SDK (Software Development Kit), supporting multi¬platform communication, in the user interface;
identifying, by the central management unit a communication protocol of the smart object;
requesting a key corresponding to the identified standard of the object for the detected object and for a selected operation from a Secure Access Module (SAM) having a plurality of physical keys;
authenticating the object by means of the key;
opening a communication channel between the SDK and the smart object, by means of the central management unit;
instructing the SDK which communication protocol to use when performing operations on that smart object;
sending instructions to the SDK; and
transferring the instructions from the SDK to the user interface for implementation.

11. The method according to claim 8, wherein said provider backend performs operations on multiple smart objects simultaneously.

12. A method for performing an update operation on a smart object using a personal computing platform running an Internet browser, the method comprising:
running a universal, multi-platform “dumb” Web SDK (Software Development Kit), supporting multi-platform communication, on the browser;
creating a random key for connecting to a proxy server and connecting to the server; running a Desktop SDK installed on the personal computing platform to receive an address of the Proxy;
opening a first secure Web connection from the Web SDK to the proxy and a second secure Web connection from the desktop SDK;
securely requesting the desktop SDK to perform a Dump to the smart object by means of a user interface including a smart object reader/writer and a processor;
securely performing the requested Dump by the desktop SDK; receiving a request for a new contract to be loaded to the smart object;
securely requesting the desktop SDK to write the new contract to the smart object; securely writing the requested new contract by the user interface to the smart object; and
providing an indication when the operation has been completed successfully.

13. The method according to claim 12, further comprising:
sending updates regarding a state of the smart object reader/writer (connected, disconnected, no card, error) from the Desktop program to the Web; and
displaying instructions on the user interface, accordingly.

14. The method according to claim 12, further comprising receiving and storing corroborating documents to support the request, after the step of receiving a request.

15. The method according to claim 14, further comprising reviewing the corroborating documents before the step of storing.

16. A system for creating a communication channel between a smart object and a smart processing device, the system comprising:
a smart object;
a smart processing device having a detector for detecting the smart object, said device running an Android operating system having a timer;
an NFC (Near Field Communication) chip disposed in said smart device and arranged to establish a communication channel between said smart processing device and said smart object for performing a transaction on said smart object, and to output signals at pre-set fixed¬length time delay intervals of the timer to the smart object; and
an application having a module arranged to switch operation of the Android operating system between two modes when the detector detects the smart object adjacent the smart processing device,
wherein, in a first mode, the NFC chip is arranged to output a signal to the smart object after each fixed-length time delay interval and in a second mode, the NFC chip is arranged to output a signal after at least one pre-selected time delay interval longer than the fixed-length time delay interval, thereby preventing disconnection of the communication channel while the transaction is performed over the communication channel.

17. The system according to claim 16, wherein, in the second mode, the application is arranged to repeatedly reset the timer until the transaction is completed, thereby creating the longer time delay.

18. The system according to claim 16, wherein, in the second mode, the application is arranged to run the NFC chip in Reader Mode and to select the longer time delay interval so as to correspond to time for performance of the transaction.

19. A method for creating a communication channel between a smart object and a smart processing device having a detector, for detecting the smart object, and an NFC chip, the device running an Android operating system having a timer, the method comprising:
running the NFC chip with a pre-set, fixed length time delay interval before sending output signals to a smart object;
detecting the presence of a smart object;
creating a communication channel between the smart processing device and the smart object;
performing a transaction over the communication channel; and
creating a selected time delay interval before sending said output signals to said smart object, wherein the selected time delay interval is longer than said pre-set, fixed length time delay interval while performing the transaction.

20. The method according to claim 19, wherein the step of creating a selected time delay interval includes running the NFC chip in Reader Mode and creating said longer selected time delay interval to cause the smart device to enter a communication mode, wherein the communication channel remains open so as to permit performance of the transaction.

21. The method according to claim 19, wherein the step of creating a selected time delay interval includes:
a. determining that the transaction is not completed;
b. resetting the timer; and
c. repeating steps a. and b. until the transaction is completed.
